(19) United States
(12) Patent Application Publication
(10) Pub. No.: US 2006/0290618 A1
(43) Pub. Date: Dec. 28, 2006

(54) Display panel conversion data deciding method and measuring apparatus

(76) Inventor: Masaharu Goto, Saitama (JP)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/558,911

(22) PCT Filed: Sep. 2, 2004
(86) PCT No.: PCT/JP04/13095

§ 371 Date: Nov. 30, 2005

(30) Foreign Application Priority Data
Sep. 5, 2003 (JP) 2003-314587

(51) Int. Cl. G09G 3/30

(52) U.S. Cl. 345/77

(57) ABSTRACT

A high-speed correction of display panel luminance variation is performed by use of a display panel conversion data deciding method, which comprises a first measuring step for determining a first driving current of the light emitting elements of the display panel when the capacitors of the pixels other than pixels to be measured have not completely been discharged; a charging step for charging, by an analog voltage, the capacitors of the pixels to be measured; a second measuring step for determining a first driving current of the light emitting elements of the display panel when the capacitors of the pixels to be measured have been charged by the analog voltage; a driving current calculating step for determining, from the difference between the first and second driving currents, the driving current of the pixels to be measured; and a data calculating step for determining conversion data based on the driving current.

### 1. FIELD OF THE INVENTION

The present invention relates to a method for determining the conversion data of a display panel, particularly a method for determining the luminance conversion data for correcting variations in luminance of a TFT array display panel having self-emitting elements, and a display device that uses this method.

### 2. DISCUSSION OF THE BACKGROUND ART

Flat display panels used in flat-screen televisions, monitors of personal computers, display devices of portable telephones, and the like must be capable of responding to fast-moving images and of vivid color reproduction. In light of such demands, attention has recently been focused on thin film transistor (TFT) arrays with a fast response speed and active display panels that use organic EL elements and other self-emitting elements with a wide range of display colors.

Self-emitting elements are emission elements that generate light in accordance with the amount of current flowing to the element. A current that is much larger than that in a TFT array for a liquid crystal panel, which is a conventional flat display panel, must flow through a TFT array used in a display panel with this type of self-emitting elements. When the amorphous silicon film that has been used for years in liquid crystal display panels is employed in TFT arrays for display panels with self-emitting elements, it is often the case that an insufficient driving current is obtained because the carrier mobility is low. Moreover, the variations in luminance of each pixel increase as the threshold voltage of the FET changes over time as a result of charge build-up inside the gate insulation film. Therefore, a low-temperature polysilicon film, with which a high driving current is easily obtained because of high carrier mobility and there are few changes over time, is often used in TFT arrays of display panels with self-emitting elements. Nevertheless, when low-temperature polysilicon film is used, the current-voltage properties of each FET change by approximately 10% depending on the extent to which crystals form in the FET channel region. Moreover, this change can vary greatly, even among FETs that are close together inside a panel. That is, there are large fluctuations in the luminance of each pixel during production of TFT arrays that use low-temperature polysilicon film. In addition, changes over time in the light emission properties of a light-emitting element itself cannot be disregarded. In particular, EL elements use organic materials; therefore, the extent of changes over time varies considerably with the temperature, driving current, and other conditions under which an element is used. Such fluctuations in emission luminance are a source of display panel defects manifested as image irregularities and color changes.

Therefore, it is necessary to measure the fluctuations in emission luminance of each pixel and correct those fluctuations as necessary during the production and the use of conventional display panels that use self-emitting elements. The device in JP (Kokai) [Unexamined] 5[1993]-80101 is a device for measuring and correcting the luminance of a display panel. By means of this device, a test pattern is read by a sensor located inside or outside a liquid crystal display panel, the light output properties of the display panel are measured, and the corrected data are renewed.

In addition, the technology disclosed in JP (Kokai) [Unexamined] 2002-40074 is a technological means for measuring the driving current of an EL element and evaluating defects in an EL display panel. That is, this is technology whereby the precise driving current of a pixel to be measured is found and defects in a display panel are evaluated from the difference in the driving current by measuring, as shown in FIG. 1, the driving current of a light-emitting element 115 after completely discharging a charged capacitor 130 of a pixel 117 of a display panel comprising a pixel selection transistor 131 for selecting pixels, capacitor 130, a drive transistor 118 for passing a driving current that is in accordance with the voltage of capacitor 130, and self-emitting element (EL element) 115, such as an EL display panel 108.

By means of the above-mentioned method, the next pixel must be measured once the driving current of a pixel under test has been measured and then the capacitor of that pixel under test is completely discharged, that is, discharged to the threshold value of the drive transistor or lower; therefore, considerable time between pixel measurements is needed in order to continuously measure pixels. Moreover, an EL element itself has a capacitance component 143 and an impedance component 141, as shown by the equivalent circuit in FIG. 6. Therefore, once application of the driving current has been initiated, it takes the amount of time corresponding to a time constant to reach the steady state (state when the driving current is virtually constant). Consequently, there is a problem with continuous measurement of the many pixels in a display panel in that such measurement takes a very long time.

However, one property of human vision is that differences in the luminance between pixels that are close to one another are noticed as image irregularities and changes in color, but differences in the luminance of pixels that are not close to one another are not noticed. That is, the difference in relative luminance between pixels that are close to one another should be measured in order to correct fluctuations in luminance. Consequently, there is a need for a measurement method that is simpler and faster than conventional methods because absolute measurement in order to correct fluctuations in luminance is not necessary.

### SUMMARY OF THE INVENTION

The present invention solves the above-mentioned problems with a method for determining the conversion data of a display panel, characterized in that it is a method for determining the conversion data of a display device having a display panel, wherein there are disposed, in matrix form, multiple pixels, each having a capacitor, a drive circuit for controlling current or voltage based on the voltage of the capacitor, and a self-emitting element driven by the drive circuit, and a luminance signal generating means for applying to the capacitor an analog voltage obtained by conversion of the luminance data based on conversion data, and in that it comprises a first measurement step for finding a first driving current of the light-emitting elements of the display panel when the capacitors of the pixels other than the pixel under test have not been completely discharged; a charging step for charging the capacitor of the pixel under test to the analog voltage; a second measurement step for measuring a second driving current of the light-emitting elements of the display panel when the capacitor of the pixel under test has been charged to the analog voltage; a driving current calculation step for finding the driving current of the pixel under test from the difference between the first driving current and the second driving current; and a data calculation step for finding the conversion data based on the driving current.

That is, even if there is a pixel present in the display panel in which the capacitor has not been sufficiently discharged prior to the test, it is possible to cancel the driving current of that pixel and perform high-speed measurement of variations in properties between pixels by using a method whereby the driving current of light-emitting elements of a display panel are measured before a pixel under test is measured and the driving current of the light-emitting elements of the pixel under test is found based on the difference from the driving current of the light-emitting elements of the display panel when the pixel under test has been driven. Furthermore, measurement at an even higher speed is possible by measuring, before the light-emitting elements are driven, every predetermined number of pixels and interpolating from the measurement results the current before driving unmeasured pixels. In this case, there are fluctuations in the properties of each pixel and the precise pre-driving current therefore cannot be found by interpolation, but because the absolute fluctuations are small in proportion to the amount of discharge, the effect of the variations between adjacent pixels can be disregarded.

Moreover, the present invention solves the above-mentioned problems with a method for determining the conversion data of a display panel, characterized in that it is a method for determining the conversion data of a display panel having a display panel comprising a TFT array and self-emitting elements, a luminance signal generating means for generating luminance signals by converting luminance data to conversion data, a drive means for driving the self-emitting elements by the luminance signals, and a measurement means for measuring the driving current and/or emission luminance of the light-emitting elements of the TFT array, and in comprising a step for driving the self-emitting element of the pixel under test, a step for performing the measurement before the driving current of the pixel under test has reached a saturated state, and a step for determining the conversion data based on the results of the measurement. That is, measurement at an even higher speed is possible by performing the measurement before the emission luminance or driving current of the pixel under test reaches a saturated state (the emission luminance or measurement current reach the steady state when an element is driven).

The present invention makes possible the high-speed correction of variations in luminance of a display panel.

### BRIEF DESCRIPTION OF THE DRAWINGS

FIG. 1 is a general view of an example of the measuring apparatus of the present invention.

FIG. 2 is a drawing that shows the measurement points of the example.

FIG. 3 is a drawing that shows another version of the measurement points.

FIG. 4 is an explanatory drawing of measurement luminance.

FIG. 5 is a drawing that shows a method for controlling a luminance sensor.

FIG. 6 is a drawing that shows an equivalent circuit of an EL element.

FIG. 7 is a drawing that shows the conversion data of a luminance signal generating circuit.

FIG. 8 is a drawing that shows a method for determining conversion data.

### DETAILED DESCRIPTION OF THE PREFERRED EMBODIMENT

Preferred embodiments of the display device of the present invention will now be described in detail while referring to the attached drawing. EL elements are used as the self-emitting elements in these examples, but the present invention is not limited to an EL display panel and can be used on display panels that use other self-emitting elements, such as a display panel that uses light-emitting diodes.

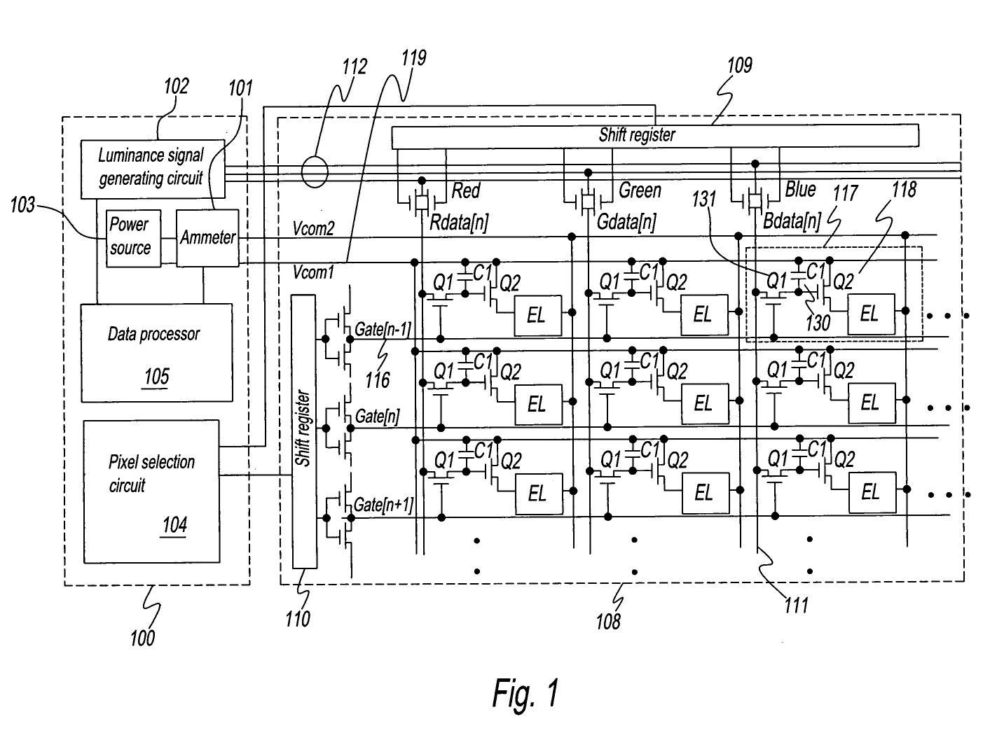

FIG. 1 is a structural diagram of the display device of the present invention. The display device comprises a control part 100 of the panel and an EL display panel 108. Control part 100 comprises: a selection means in the form of a pixel selection circuit 104 connected to shift registers 109 and 110 of EL display panel 108; a luminance signal generating circuit 102, which is connected to the outside input of luminance data and a luminance signal line 112 of EL display panel 108, and provides the conversion data of each pixel; a measurement means in the form of an ammeter 101; a drive means in the form of a power source 103 connected through ammeter 101 to a common line 119; and a conversion data determination means in the form of a data processor 105, which is connected to ammeter 101 and has a memory and a data processing circuit. As shown in FIG. 7, luminance signal generating circuit 102 has a conversion table in which luminance data 10 corresponding to low luminance and luminance data 250 corresponding to high luminance are stored for every pixel (displayed by column number and row number).

Moreover, EL display panel 108 comprises multiple pixels disposed in matrix form; a data line 111 and a gate line 116 for selecting pixels; and shift registers 109 and 110 connected to data line 111 and gate line 116, respectively. A pixel 117 comprises a pixel selection transistor Q1 131 connected to data line 111 and gate line 116; a capacitor C1 130 connected to pixel selection transistor 131 and a common line 119; an EL element 115; and a drive transistor Q2 118 connected to capacitor 130, pixel selection transistor 131, and EL element 115. A constant-current circuit is used as the drive circuit in the present example, but a voltage control circuit can also be used.

The operation of the display device in FIG. 1 will now be described. The display device has a normal display mode and a corrected mode. First, in the normal display mode, pixel selection means 104 outputs pixel location signals in accordance with pixel signals (pixel position data and luminance data) that have been input from the outside, and shift registers 109 and 110 select the data line and the gate line corresponding to the pixel position. For instance, when gate line 116 and data line 111 are selected, pixel 117 located at the point of intersection is selected. Similarly, luminance signal generating circuit 102 calculates the analog voltage corresponding to the input luminance data from the conversion data (luminance data 10 and luminance data 250) corresponding to each pixel and feeds that voltage to luminance signal line 112. For instance, when the luminance data that has been input is 150, the voltage is 2.17 V (=1+(3−1)/250−10)×(150−10)) for the pixel at column=0 and row=0. The luminance signal of luminance signal line 112 is supplied to data line 111 that has been selected by pixel selection circuit 104. On the other hand, pixel selection transistor 131 is turned on at selected pixel 117, capacitor 130 is charged by the luminance signal on data line 111, and then the above-mentioned voltage is maintained by turning off pixel selection transistor 131. The current of drive transistor 118, which is a constant-current circuit, is controlled by the voltage of capacitor 130, and a driving current is applied to EL element 115. EL element 115 emits light in an amount corresponding to the amount of driving current.

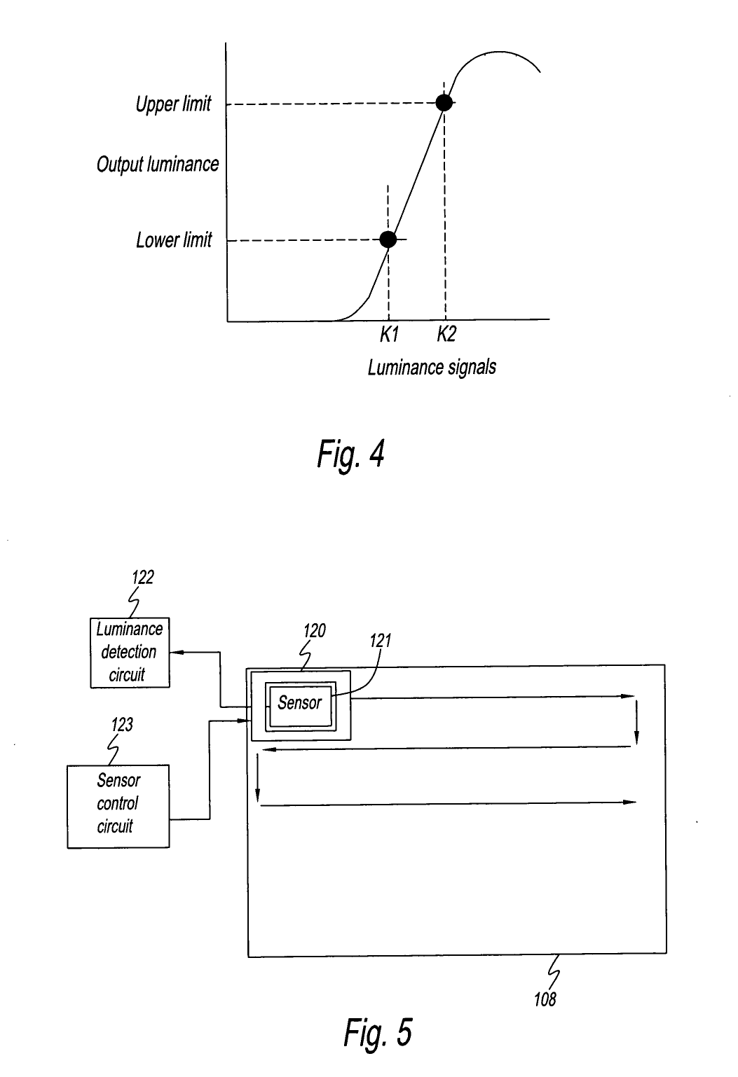

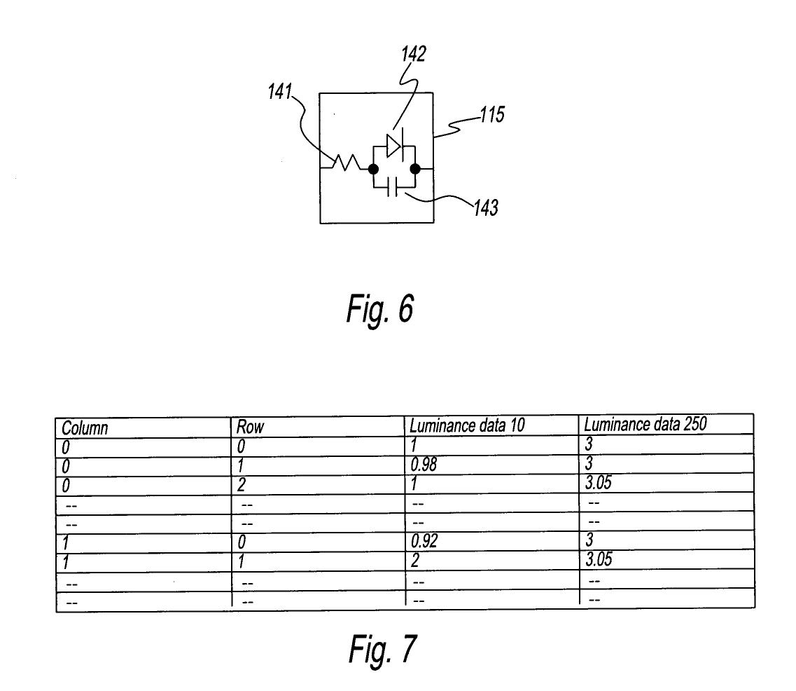

It should be noted that the luminance data in the present example are limited to 0 and within a range of 10 to 250; therefore, converted values of luminance data 10 and luminance data 250 are used as conversion data, but any luminance data can be used as the conversion data, and it is possible to select from a range of numerical values for the luminance data. Linear interpolation is used in the present example; therefore, luminance data should be selected that correspond to the lower limit and upper limit of a region wherein the driving current (which is proportional to the capacitor applied voltage) has linear properties with respect to the luminance data as in FIG. 4, but it is also possible to use a region having nonlinear properties when nonlinear interpolation is used.

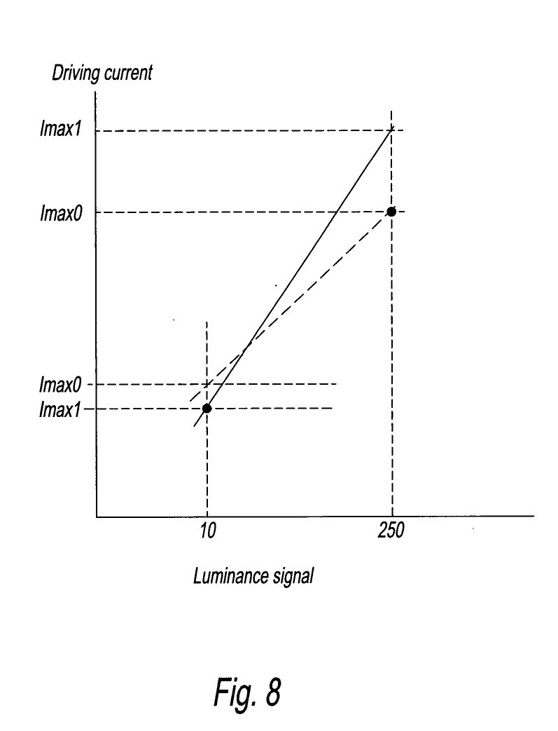

Next, the operation of the correction mode will be described. A description of the operation of the structural parts inside EL display panel 108 will be omitted because it is the same as for the normal mode. First, 0 V luminance signals are applied to luminance signal line 112, selection transistor 131 of each pixel is selected in succession by pixel selection circuit 104, and all capacitors 131 of EL display panel 108 are initialized. Once initialization is completed, the current flowing to ammeter 101 is stored in the memory of data processor 105. Next, pixel under test 117 to be measured is selected by pixel selection circuit 104. Analog voltage corresponding to luminance data 10 is applied from luminance signal generating circuit 102 to luminance signal line 112 at this time. The current flowing to ammeter 101 is stored in the memory of data processor 105 also at this time. The driving current Imin1 of pixel under test 117 can be found from the difference between the current before and the current after EL element 115 has been driven, the values of which are stored in the memory. When Imin1 is only 80% of the pre-set Imin0 as in FIG. 8, the conversion data of luminance data 10 of luminance signal generating circuit 102 is increased by 1.25 times (=1/0.8).

Next, luminance signal generating circuit 102 applies 0 V to luminance signal line 112 and capacitor 130 discharges. It takes time until capacitor 130 is completely discharged, that is, until capacitor 130 is discharged to the threshold voltage of transistor 118; therefore, pixel selection transistor 131 of the pixel in question is turned off before the capacitor is discharged to the threshold voltage and the same measurement is performed on the next pixel under test. A pre-determined current continues to flow to drive transistor 118 of pixel 117 under the residual potential of capacitor 130 of pixel 117; therefore, the current flowing to ammeter 101 is stored in the memory of data processor 105 before the EL element of the next pixel under test is driven and the driving current of the next pixel under test is found from the difference between that current and the current when the EL element is driven. Thus, high-speed determination of conversion data is possible by starting the measurement of the next pixel under test before the capacitor of the pixel under test has been completely discharged.

The panel is initialized once the measurement of luminance data 10 of the pixel requiring measurement has been completed. Moreover, the measurement and conversion data are determined for luminance data 250 by the same process. That is, as shown in FIG. 8, the driving current Imax1 is found when luminance signals corresponding to luminance data 250 have been applied to capacitor 131, Imax1 is compared with pre-determined current value Imin1, and the conversion value of luminance data 250 of luminance signal generating circuit 102 is revised. Thus, pixels having the properties shown by the solid line in FIG. 8 can be corrected to realize predetermined properties as represented by the broken line.

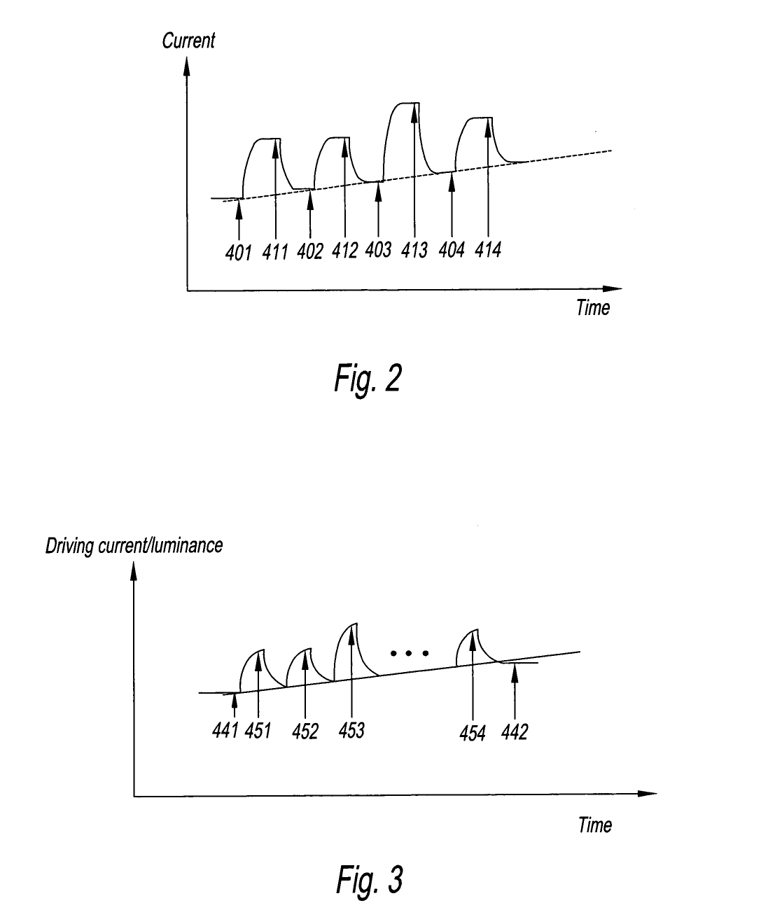

The measurement points of ammeter 101 in the present example are shown in FIG. 2. References 401, 402, 403, and 404 in the figure are the currents that flow to ammeter 101 before the driving current flows to the EL elements of the pixel under test, and references 411, 412, 413, and 414 are the driving currents when the EL element of the pixel under test has been driven. Once a pixel under test has been measured, the next pixel is measured without completely discharging capacitor C1; therefore, the current that flows to ammeter 101 gradually increases before the EL element of the pixel under test is driven.

The discharge properties of the capacitor vary from pixel to pixel, and the increase in current is not precisely constant, but it should be possible to maintain a measurement and correction accuracy that is sufficient for measurement for correcting fluctuations in luminance and the driving current; therefore, if the increase in current is regarded as constant, it will not pose any problems in terms of practical use. Consequently, the display device of the present example has a mode for measuring the current before measurement for a certain number of pixels each time without measuring the current before measurement of every pixel, linearly interpolating from the most recently measured driving current, and finding the current before measurement of the pixel under test. When this mode is selected, for instance, driving current values 402 and 403 are found by interpolation from the actual measurements of driving currents 401 and 404 during the step wherein the difference component after driving current 401 has been measured until driving current 404 is measured is calculated by data processor 105 without actually measuring the driving current flowing to display panel 108 before the EL element of the pixel under test is driven. Thus, high-speed determination of conversion data is possible by reducing the number of times the current is measured when a pixel under test is not driven.

The display device comprises measurement means and conversion data means in the present example. Therefore, pixels under test can be measured as needed and fluctuations in the driving current can be corrected, not only when a device is being made but also when it is being used. As a result, it is not necessary to install variation correction means, such as a current mirror circuit or another self-correcting circuit, for each pixel 117 of display panel 108; therefore, the device structure can be simplified and an inexpensive device can be provided.

Moreover, control part 100 of the present example can be separated from the display device as an individual measuring apparatus. In this case, the display device comprises a luminance signal generating circuit 102, a power source 103, and a pixel selection circuit 104 that are used for normal display, and the measuring apparatus comprises luminance signal generating circuit 102, power source 103, and pixel selection circuit 104 that are used for determination of conversion data. The structure and operation of the measuring apparatus are the same as for the above-mentioned correction mode, but it is necessary to transmit the conversion data that have been determined by measurement to the luminance signal generating circuit housed inside the display device connected to the outside. Therefore, it is necessary to install an output device in luminance signal generating circuit 102 of the measuring apparatus.

The method for finding the difference between the measurement before the EL circuit of a pixel under test is driven and the measurement when the EL circuit is being driven described above can also be used as the method for directly measuring luminance only as shown in JP (Kokai) [Unexamined] 5[1993]-80101. FIG. 5 is a drawing showing a sketch of a luminance measuring apparatus added to the display device of the present example. A luminance sensor 121 that scans EL display panel 108; a luminance detection circuit 122 that is connected to luminance sensor 121 and detects luminance from the output signals from a sensor 121, and a sensor control circuit 123 that controls the operation of sensor 121 are added to the device structure in FIG. 1. A light-blocking means 120 is set up around sensor 121 and sensor 121 is constructed such that it can detect only the light from pixels adjacent to the pixel under test.

The operation of the device that also measures luminance will now be described. Operations other than measurement of luminance are the same as for the above-mentioned device and the value is a description is therefore omitted. First, sensor control circuit 121 moves sensor 121 to the pixel under test. Luminance is measured before pixel under test 117 is driven and this value is stored in the memory of data processor 105. Next, EL element 115 of pixel under test 117 is driven by the driving current corresponding to luminance data 10 and luminance data 250, the luminance when the element is driven is measured, and the conversion data of luminance signal generating circuit 102 are corrected. Moreover, capacitor 130 of pixel under test 117 is discharged and the next pixel is measured in succession before the capacitor is completely discharged.

As shown in FIG. 3, it is possible to determine conversion data at an even higher speed by measuring the driving current or emission luminance of each pixel before the driving current of emission luminance of the pixel under test reaches the steady state and a specific time after the driving current is first applied. In this case, the precise driving current and emission luminance in the steady state cannot be measured, but there is a proportional relationship between the driving current and the emission luminance at a specific time after current is first applied and the driving current and emission luminance in the steady state; therefore, the conversion data can be corrected using measurements when in a state of transition.

It should be noted that the present embodiment and modified examples thereof are only one embodiment for describing the present invention as cited in the claims and persons skilled in the art will recognize that a variety of modifications are possible within the scope of the claims.

What is claimed is:

1. A method for determining the conversion data of a display panel, characterized in that it is a method for determining the conversion data of a display device having
a display panel, wherein there are disposed in matrix form multiple pixels, each having a capacitor, a drive circuit for controlling current or voltage based on the voltage of the capacitor, and a self-emitting element driven by the drive circuit, and
a luminance signal generating means for applying to the capacitor an analog voltage obtained by conversion of luminance data based on conversion data, comprises the steps of:
a first measurement step for finding a first driving current of the light-emitting elements of the display panel when the capacitors of the pixels other than the pixel under test have not been completely discharged;
a charging step for charging the capacitor of the pixel under test to the analog voltage;
a second measurement step for measuring a second driving current of the light-emitting elements of the display panel when the capacitor of the pixel under test has been charged to the analog voltage;
a driving current calculation step for finding the driving current of the pixel under test from the difference between the first driving current and the second driving current; and
a data calculation step for finding the conversion data based on the driving current.

2. The method of claim 1, wherein the self-emitting element is an EL element.

3. The method of claim 1, wherein the first measurement step is executed every time a specific number of pixels is measured and;
the first driving current of the pixel under test is found by interpolation from the driving current actually measured in the first measurement step immediately before and immediately after the pixel under test.

4. A display device comprises:
a display panel, wherein there are disposed in matrix form multiple pixels, each having a capacitor, a drive circuit for controlling current or voltage based on the voltage of the capacitor, and a self-emitting element driven by the drive circuit;
a selection means for selecting any pixel under test;
a luminance signal generating means for applying to the capacitor an analog voltage obtained by conversion of luminance data based on conversion data;
a measurement means for measuring the driving current of the light-emitting elements of the multiple pixels; and
a conversion data determination means for finding the conversion data based on the difference between the first driving current of the light-emitting elements of the multiple pixels when the capacitors of pixels other than the pixel under test have not been completely discharged and the second driving current of the light-emitting elements of the multiple pixels when the capacitor of the pixel under test has been charged to the analog voltage.

5. A measuring apparatus of a display panel, characterized in that it is a measuring apparatus of a display panel wherein there are disposed in matrix form multiple pixels, each having a capacitor, a drive circuit for controlling current or voltage based on the voltage of the capacitor, and a self-emitting element driven by the drive circuit, comprises:
a selection means for selecting any pixel under test,
a luminance signal generating means for applying to the capacitor an analog voltage obtained by conversion of luminance data based on conversion data;
a measurement means for measuring the driving current of the light-emitting elements of the multiple pixels;
a conversion data determination means for finding the conversion data based on the difference between the first driving current of the light-emitting elements of the multiple pixels when the capacitors of pixels other than the pixel under test have not been completely discharged and the second driving current of light-emitting elements of multiple pixels when the capacitor of the pixel under test has been charged to the analog voltage; and
an output means for outputting the conversion data.

6. A method for determining conversion data of a display panel, characterized in that it is a method for determining the conversion data of a display device having a display panel, wherein there are disposed in matrix form multiple pixels, each having a capacitor, a drive circuit for controlling current or voltage based on the voltage of the capacitor, and a self-emitting element driven by the drive circuit, and
a luminance signal generating means for applying to the capacitor an analog voltage obtained by conversion of luminance data based on conversion data, comprises the steps of:
a first measurement step for finding the first emission luminance of the display panel when the capacitors of pixels other than the pixel under test have not been completely discharged;
a charging step for charging the capacitor of the pixel under test to the analog voltage,
a second measurement step for measuring the second emission luminance of the display panel when the capacitor of the pixel under test has been charged to the analog voltage;
an emission luminance calculation step for finding the emission luminance of the pixel under test from the difference between the first emission luminance and the second emission luminance; and
a data calculation step for finding the conversion data based on the emission luminance.

7. A method for determining the conversion data of a display panel, having a display panel comprising a TFT array and self-emitting elements;
a luminance signal generating means for generating luminance signals by converting luminance data to conversion data;
a drive means for driving the self-emitting elements by the luminance signals, and a measurement means for measuring the driving current and/or emission luminance of the light-emitting elements of the TFT array,
comprises the steps of:
a step for driving the self-emitting element of the pixel under test,
a step for performing the measurement before the driving current or emission luminance of the pixel under test has reached a steady state; and
a step for determining the conversion data based on the results of the measurement.
